(19) United States
(12) Patent Application Publication
(10) Pub. No.: US 2008/0196067 A1
(43) Pub. Date: Aug. 14, 2008

(54) Mobile communication device, method and system for managing broadcast program information

(75) Inventor: Sung Joon Ryu, Gyeonggi-do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG ELECTRONICS INC.

(21) Appl. No.: 11/704,749

(22) Filed: Feb. 8, 2007

(30) Foreign Application Priority Data
Feb. 8, 2007 (KR) 10-2006-0012205

(51) Int. Cl. H04N 7/173

(52) U.S. Cl. 725/62; 455/550.1

(57) ABSTRACT

A mobile communication device, method and system for managing broadcast program information are disclosed. The mobile communication device has a broadcast program information managing function including a transmission/reception module receiving broadcast program information, and a controller extracting broadcast program information corresponding to user information from the received broadcast program information. Accordingly, it is possible to allow a user to rapidly select a desired program by providing only broadcast program information suitable for the user.

### CROSS-REFERENCE TO RELATED APPLICATION

This application claims the priority benefit of Korean Patent Application No. 10-2006-0012205, filed on Feb. 8, 2006, which is hereby incorporated by reference as if fully set forth herein.

### BACKGROUND OF THE INVENTION

1. Field of the Invention

The present invention is directed to a mobile communication device, method and system for managing broadcast program information.

2. Discussion of the Related Art

As mobile communication technologies have been developed, a digital broadcasting service, which enables a user to view digital broadcasting, has attracted much attention. Specifically, for such a digital broadcasting service, representative examples of the digital broadcast standards are a European Digital Audio Broadcasting (DAB) service based on the Eureka-147 [ETSI EN 300 401] standard, a Digital Video Broadcasting-Terrestrial (DVB-T) service of Europe, a Digital Video Broadcasting-Handheld (DVB-H) service of Europe, a Media Forward Link Only (FLO) service led by Qualcomm Incorporated of the United States, and a Digital Multimedia Broadcasting (DMB) service of the Republic of Korea.

The digital broadcasting service having high channel efficiency can simultaneously transmit a plurality of programs via a single channel such that the digital broadcasting service can provide the plurality of programs to viewers. Accordingly, there is a necessity to provide broadcast program information such that the viewers can easily select a broadcast program. As a service for providing the broadcast program information, an electronic program guide (hereinafter, referred to as “EPG”) service of the DMB and an electronic service guide (hereinafter, referred to as “ESG”) service of the DVB-H are provided.

However, as the quantity of broadcast program information has increased, there is a limitation to display a screen. In addition, an operation for searching for a desired broadcast program becomes troublesome. Specifically, in a mobile communication device, there is a limitation to increase storage capacity, and it is inconvenient to display the broadcast program information on a small-sized display unit.

Meanwhile, as the digital broadcasting service has been developed, a broadcast program rating system and a pay broadcasting service have been introduced. Accordingly, the digital broadcasting service provides a system for allowing only a user, who is entitled to receive the service, to conditionally view a broadcast program.

For example, a conditional access system of the DMB conditionally provides a broadcast program on the basis of the entitlement of the user. In the conditional access system, a broadcast center scrambles a broadcast signal and then transmits the scrambled broadcast signal. A reception side descrambles the received broadcast signal such that only an entitled user can view the broadcast program.

However, when the conditional access system is used, the broadcast program is not provided to a user who is not entitled to receive the service, but information on the broadcast program is provided without restriction. A conditional access (CA) area of EPG data includes information as to whether the broadcast program uses the conditional access system or not, but does not define detailed restriction contents.

Accordingly, although the conditional access system is used, the information on the broadcast program may be unnecessarily provided to the user who is not entitled to receive the service.

Currently, the EPG service cannot provide a variety of information on the broadcast program according to a variety of subscription environments and preferences of the user.

### SUMMARY OF THE INVENTION

An object of the present invention is to provide a device and method of extracting only broadcast program information corresponding to a variety of subscription conditions or rights of a user from a variety of broadcast program information and a mobile communication device using the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and, in accordance with the purpose of the invention as embodied and broadly described herein, a method of managing broadcast program information comprises: receiving, by a mobile communication device, the broadcast program information; and extracting broadcast program information corresponding to user information from the received broadcast program information.

In another aspect of the present invention, there is provided a mobile communication device having a broadcast program information managing function comprising: a transmission/reception module configured to receive broadcast program information; and a controller configured to extract broadcast program information corresponding to user information from the received broadcast program information.

In another aspect of the present invention, there is provided a mobile communication device having a broadcast program information managing function for extracting broadcast program information corresponding to user information from received broadcast program information.

In yet another aspect of the present invention, there is provided a system having a broadcast program information managing function comprising: an information generating server generating broadcast program information; a broadcast center transmitting the generated broadcast program information to a mobile communication device; and the mobile communication device extracting broadcast program information corresponding to user information from the broadcast program information received from the broadcast center.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention. In the drawings:

FIG. 1 illustrates the structure of EPG data;

FIG. 2 illustrates a scheme of a conditional access (CA) area included in EPG data according to an embodiment of the present invention;

FIG. 3 is a block diagram showing the configuration of a mobile communication device having a broadcast program information managing function according to an embodiment of the present invention;

FIG. 4 is a block diagram showing the configuration of a controller shown in FIG. 3;

FIG. 5 is a flowchart illustrating a method of managing broadcast program information according to an embodiment of the present invention; and

FIG. 6 illustrates a system for managing broadcast program information according to the embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In describing the present invention, if it is determined that the detailed description of a related known function or construction renders the scope of the present invention unnecessarily ambiguous, the detailed description thereof will be omitted.

A service for selectively extracting broadcast program information, according to the present invention, is applicable to a broadcast system using a variety of digital broadcast standards.

The term electronic program guide (hereinafter, “EPG”) service is indicative of a service for allowing a broadcast center to provide a variety of information on a broadcast program to a user's terminal.

The term “EPG data” described herein is indicative of data including the broadcast program information provided by the EPG service.

The term “broadcast program information” is indicative of broadcast program information included in the EPG data and includes information such as a program name, a broadcast start time, a broadcast end time, a broadcast period, contents, a genre, and a keyword.

The terms described herein include all terms having the same meanings as the described terms and are not simply limited to the described terms. The above-described digital broadcasting system is applicable to a service for providing the broadcast program information.

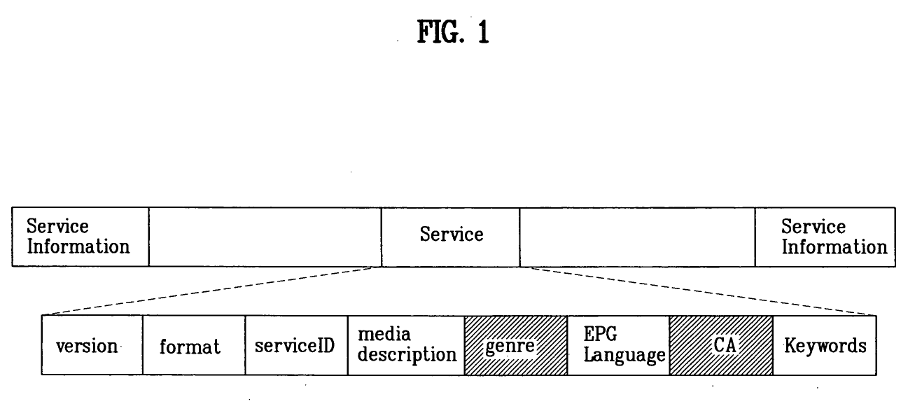

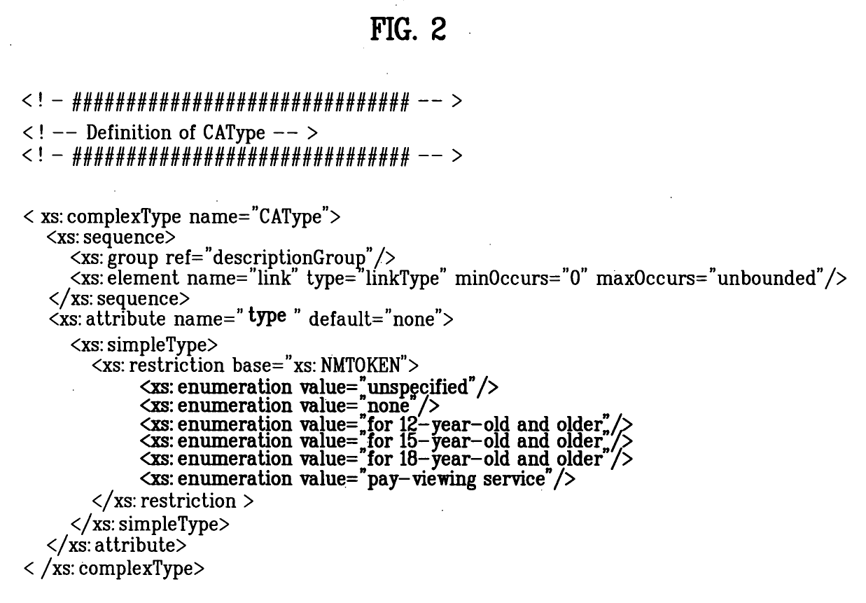

FIG. 1 illustrates the structure of service information in the EPG data which is received by a mobile communication device, and FIG. 2 illustrates a scheme of a conditional access (CA) area included in the EPG data according to an embodiment of the present invention.

Hereinafter, the structure of the EPG data according to the embodiment of the present invention will be described in detail with reference to FIGS. 1 and 2. The EPG service provides service information and program information.

In the data structure shown in FIG. 1, the service information includes genre information and service access rights information, which are used for extracting broadcast program information corresponding to user information.

In particular, in the data structure shown in FIG. 1, the CA area may include the service access rights information and a genre area may include the genre information.

The EPG data is represented in an extensible markup language (XML) format. Accordingly, data included in the CA area or the genre area of the EPG data is also represented in the XML format. The XML format can extend without changing data, if necessary.

FIG. 2 illustrates the scheme of the CA area including the service access rights information represented in the XML format. Specifically, according to the present invention, viewable age information or pay-viewing information is included. Since the CA area is represented in the XML format, the CA area may include a variety of other service access rights information, in addition to the viewable age information and the pay-viewing information.

For example, if the viewable age is at least 18, a field <xs:enumeration value=for 18-year-old and older> may be added. If the viewable age is at least 12, a field <xs:enumeration value=for 12-year-old and older> may be added. If the viewable age is at least 15, a field <xs:enumeration value=for 15-year-old and older> may be added. If the pay-viewing is possible, a field <xs:enumeration value=pay-viewing service> may be added.

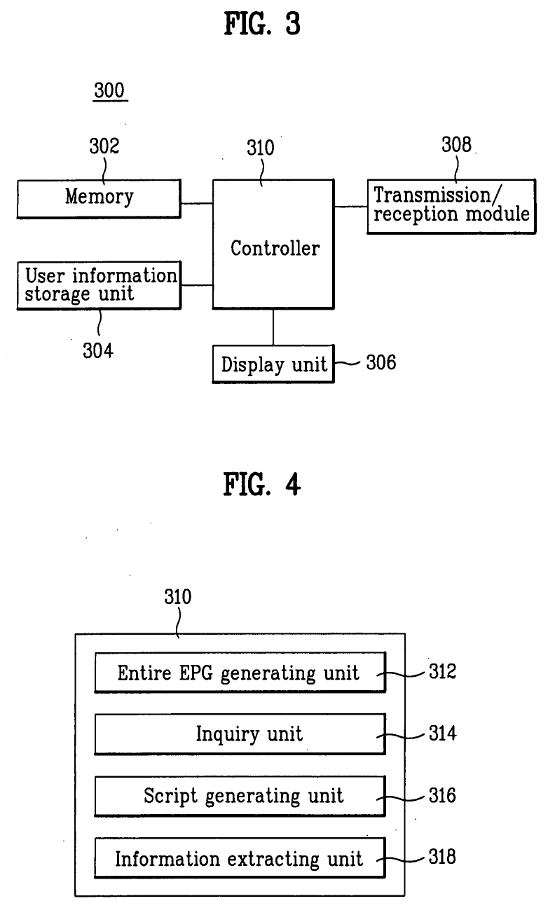

Now, how to receive the EPG data including the service access rights information or the genre information and to extract the broadcast program information corresponding to the user information from the EPG data will be described in detail with reference to FIGS. 3 to 5.

FIG. 3 is a block diagram showing the internal configuration of a mobile communication device 300 according to an embodiment of the present invention.

As shown in FIG. 3, the mobile communication device 300 includes a memory 302, a user information storage unit 304, a display unit 306, a transmission/reception module 308 and a controller 310.

The memory 302 stores a variety of programs for controlling an overall operation of the mobile communication device 300. When the overall operation of the mobile communication device 300 is performed by the controller 310, input/output data is stored in the memory 302. Specifically, in the present invention, the memory 302 stores broadcast program information received by the transmission/reception module 308 and broadcast program information extracted from the received broadcast program information based on user information. The memory 302 stores the extracted broadcast program information and outputs the extracted broadcast program information to the display unit 306 when an output signal is received from the controller 310.

The user information storage unit 304 stores information on a user of the mobile communication device 300.

For example, the user information includes at least one of the age of the mobile communication device's user, the sex of the user, rights on a pay broadcasting service, subscription of a specific channel service, and user's preferences on the broadcast program. The user's preferences are indicative of a preference degree of the user on the broadcast programs based on a broadcast program genre and a viewing time. The user information may be arbitrarily set by the user or received from a mobile network or a broadcast network.

The rights on the pay broadcasting service or the subscription of the specific channel service among the user information may be automatically set by subscripting to the pay broadcasting service or the specific channel service or may be received from the broadcast network.

The user information may include an identification number of the mobile communication device 300 or an electronic serial number of the mobile communication device. The identification number or the electronic serial number is previously stored in the mobile communication device 300 without an additional operation of the user.

The user information storage unit 304 stores the user information and includes at least one of a user identity module card, a universal subscriber identity module card and a subscriber identity module card, as a card which is mainly used for user authentication.

The display unit 306 includes a liquid crystal display unit for displaying a variety of information and displays the state of the mobile communication device 300 such that the user is allowed to input a proper control signal. The display unit 306 displays the variety of information including a power state, an electric wave signal strength, date and time, a current mode state, and other user information.

Specifically, in the present invention, the display unit 306 displays the extracted broadcast program information. The display unit 306 can display the broadcast program information when receiving a predetermined display command signal. The display unit 306 can periodically display the broadcast program information according to a previously set time period.

The transmission/reception module 308 receives a broadcast signal from a broadcast center or transmits a signal to the broadcast center. The transmission/reception module 308 also transmits or receives a variety of communication signals via the mobile network. Specifically, the transmission/reception module 308 receives the broadcast program information. The broadcast program information is included in the EPG data of the DMB.

If the broadcast program is, for example, a DMB broadcast program, the transmission/reception module 308 includes a DMB module. The transmission/reception module 308 receives the EPG data at a predetermined period. When the broadcast center changes the EPG data, the transmission/reception module 308 receives the changed EPG data which is transmitted from the broadcast center.

The controller 310 is a main part of the mobile communication device 300, which controls the overall operation of the mobile communication device. The controller 310 includes an arithmetic unit, a register, a program counter, a command decoder and a control circuit.

Specifically, in the present invention, the controller 310 extracts the broadcast program information corresponding to the user information from the broadcast program information received by the transmission/reception module 308.

The extracted broadcast program information may be visually output via the display unit 306 or audibly output via a speaker (not shown).

The controller 310 enables the memory 302 to store the extracted broadcast program information and enables the display unit 306 or the speaker (not shown) to output the extracted broadcast program information when a display command signal is input. At this time, the controller 310 checks whether the display command signal for the broadcast program information is input by the user or a time for outputting the broadcast program information has arrived according to a scheduler which is previously stored and determines whether the broadcast program information is output.

As shown in FIG. 4, the controller 310 includes an entire EPG generating unit 312, an inquiry unit 314, a script generating unit 316, and an information extracting unit 318 for the extraction of the broadcast program information. Hereinafter, for convenience of description, it is assumed that the broadcast program information is the EPG data.

The entire EPG generating unit 312 converts entire EPG data received by the transmission/reception module 308 from a binary format into the XML format.

The inquiry unit 314 inquires about the user information stored in the user information storage unit 304. The user information may be previously stored in the user information storage unit 304 or received from the mobile network by request when receiving the EPG data.

The script generating unit 316 generates a script which is a conditional statement for extracting the broadcast program information using the user information inquired by the inquiry unit 314. For example, the script may be represented in an extensible style language (XSL) format. The XSL is indicative of a language for describing data and a document represented in the XML format to be suitable for a certain condition. Accordingly, the script is not limited to the XML or the XSL and may be represented in other program language having the same function.

The script generated by the script generating unit 316 is used for extracting the EPG data until the user information is changed.

The information extracting unit 318 extracts specific EPG data from the entire EPG data generated by the entire EPG generating unit 312 using the script generated by the script generating unit 316.

The script serves as a conditional statement and allows only the broadcast program information suitable for the conditional statement to be extracted. For example, if the age of the user is 17 and the viewable age of a program 1 is at least 19, the viewable age of a program 2 is at least 15 and the viewable age of a program 3 is at least 8, the broadcast program information extracted using the script will be the information on the program 2 and the program 3 which is allowable by a 17-year-old person.

The information extracting unit 318 converts the extracted broadcast program information into valid broadcast program information. That is, the information extracting unit 318 converts the extracted broadcast program information into broadcast program information having a format which can be provided to the user.

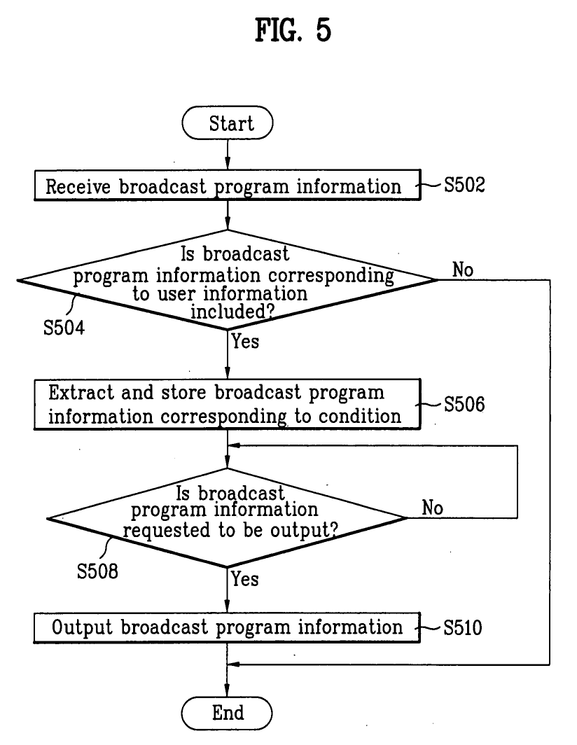

Hereinafter, a method of extracting the broadcast program information according to the embodiment of the present invention will be described with reference to FIG. 5.

The transmission/reception module 308 receives the broadcast program information (S502).

When the broadcast program information is, for example, the EPG data, the mobile communication device 300 may convert the received EPG data from the binary format into the XML format.

The controller 310 determines whether the broadcast information corresponding to the user information is included in the received broadcast program information (S504).

The user information includes the age of the mobile communication device user, the sex of the user, rights on a pay broadcasting service, subscription of a specific channel service, and user's preferences.

The controller 310, for example, determines whether the user's age, the rights on the pay broadcasting service or the subscription of the specific channel service among the user information is matched to the viewable age information or the pay-viewing information which is service access rights information included in the received broadcast program information. The controller 310 determines whether the preferences of the user information are matched to the genre information included in the received broadcast program information.

The controller 310 performs the determination step S504 using the script generated using the user information as the conditional statement. Hereinafter, the step of generating the script will be described in detail.

The inquiry unit 314 inquires about the user information stored in the user information storage unit 304. The user information is described above in detail and thus the description thereof will be hereinafter omitted.

The script generating unit 316 generates the script including the inquired user information as a condition.

If information indicating the user's age is 17, pay-viewing is possible and the preferential genre of the user is comedy are included in the user information, the script generating unit 316 may generate the script using this information as the conditional statement. The generated script may be represented in the XSL format and is used for extracting only the broadcast program information corresponding to the user information. The generated script is repeatedly used until the user information is changed.

The controller 310 extracts only the broadcast program information corresponding to the user information from the received broadcast program information when it is determined that the broadcast program information corresponding to the user information is included as the result of determination and the memory 302 stores the extracted broadcast program information (S506).

An example shown in Table 1 will be described.

| Program name | Viewable age | Pay/Free | Genre |
|---|---|---|---|
| Program 1 | For 15-year-old and older | Free | Comedy |
| Program 2 | For 8-year-old and older | Pay | Comedy |
| Program 3 | For 13-year-old and older | Pay | Drama |
| Program 4 | For 19-year-old and older | Pay | Movie |
| Program 5 | Unrestricted | Free | Comedy |
| Program 6 | For 15-year-old and older | Free | Sports |

It is assumed that the user information includes information indicating the user's age is 17, only charge-free viewing is possible and the preferential genre of the user is comedy. In the broadcast program information shown in Table 1, the broadcast program information extracted in correspondence with the user condition may be information on the program 1 and the program 5.

The controller 310 determines whether the extracted broadcast program information is requested to be output (S508).

The controller 310 determines that the extracted broadcast program information is requested to be output when an output command signal is input.

When a menu for outputting the broadcast program information is selected by the user, the controller 310 may determine that the extracted broadcast program information is requested to be output. Alternatively, when an output time of the broadcast program information is set by the user, the controller 310 may control the broadcast program information to be automatically output at the set output time.

The controller 310 outputs the extracted broadcast program information when it is determined that the extracted broadcast program information is requested to be output as the result of determination (S510).

The controller 310 may output the extracted broadcast program information via the display unit 302 or the speaker (not shown).

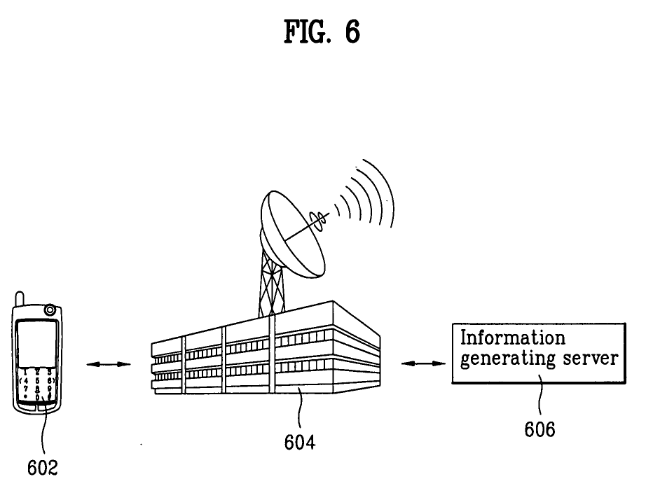

Hereinafter, a system for managing the broadcast program information according to the embodiment of the present invention will be described in detail with reference to FIG. 6.

As shown in FIG. 6, the system includes a mobile communication device 602, a broadcast center 604 and an information generating server 606.

The information generating server 606 generates broadcast program information provided by the broadcast center 604. Hereinafter, for convenience of description, the broadcast program information is defined as the EPG data.

As shown in FIGS. 1 and 2, the EPG data may include the service access rights information in the CA area. The service access rights information may include the viewable age information or the pay-viewing information. The information generating server 606 may be included in the broadcast center 604, if necessary.

The broadcast center 604 transmits the broadcast program information generated by the information generating server 606 to the mobile communication device 602 via a broadcast channel. The mobile communication device 602 may include a mobile digital television set or a multimedia player having a broadcast receiver. The mobile communication device 602 extracts only broadcast program information corresponding to the user information of the mobile communication terminal 602 from the broadcast program information received from the broadcast center 604 and outputs the extracted broadcast program information.

As described above and according to the present invention, it is possible to allow a user to rapidly select a program which is desired to be viewed by providing only broadcast program information suitable for the user.

According to the present invention, it is possible to restrict access to a program that a user is not entitled to view by selectively displaying broadcast program information without using a separate system such as a conditional access system for allowing only a subscriber, who is entitled to view the program, to view a specific program. In addition, it is possible to provide only information on the entitled program.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of managing broadcast program information in a mobile communication device, the method comprising:
receiving the broadcast program information; and
extracting broadcast program information corresponding to user information from the received broadcast program information.

2. The method of claim 1, wherein the user information comprises at least one of age of the mobile communication device's user, rights on a pay broadcasting service, subscription of a specific channel service and user's preferences on a broadcast program.

3. The method of claim 1, wherein the received broadcast program information comprises service access rights information.

4. The method of claim 3, wherein the service access rights information comprises at least one of viewable age information and pay-viewing information.

5. The method of claim 1, wherein the extracting step comprises:
determining whether the broadcast program information corresponding to the user information is included in the received broadcast program information; and
extracting the broadcast program information corresponding to the user information when it is determined to be included in the received broadcast program information.

6. The method of claim 1, wherein the extracting step comprises extracting the broadcast program information using a script generated based on the user information.

7. The method of claim 1, further comprising outputting the extracted broadcast program information.

8. The method of claim 7, wherein the outputting step is performed when an output command signal is input.

9. The method of claim 7, wherein the outputting step is periodically performed according to a set time period.

10. A mobile communication device having a broadcast program information managing function, the device comprising:
a transmission/reception module configured to receive broadcast program information; and
a controller configured to extract broadcast program information corresponding to user information from the received broadcast program information.

11. The device of claim 10, further comprising a memory configured to store the broadcast program information.

12. The device of claim 10, further comprising a user information storage unit configured to store the user information including at least one of an age of the mobile communication device's user, rights on a pay broadcasting service, subscription of a specific channel service and user's preferences on a broadcast program.

13. The device of claim 12, wherein the user information storage unit includes at least one of a user identity module card, a universal subscriber identity module card and a subscriber identity module card.

14. The device of claim 10, further comprising a display unit configured to display the extracted broadcast program information.

15. The device of claim 10, wherein the controller comprises:
an inquiry unit configured to inquire about the user information;
a script generating unit configured to generate a script using the inquired user information; and
an information extracting unit configured to extract the broadcast program information corresponding to the user information from the received broadcast program information using the generated script.

16. The device of claim 15, wherein the information extracting unit converts the extracted broadcast program information into valid broadcast program information having a format which can be provided to the user.

17. A mobile communication device having a broadcast program information managing function for extracting broadcast program information corresponding to user information from received broadcast program information.

18. A mobile communication system for managing a broadcast program information, the system comprising:
an information generating server to generate broadcast program information;
a broadcast center for transmitting the generated broadcast program information to a mobile communication device; and
a mobile communication device adapted to extract broadcast program information corresponding to user information from the broadcast program information received from the broadcast center.

19. The system of claim 18, wherein the received broadcast program information includes service access rights information.

20. The system of claim 18, wherein the broadcast center transmits the broadcast program information via a data broadcast channel.
